(19) United States
(12) Patent Application Publication
(10) Pub. No.: US 2010/0262899 A1
(43) Pub. Date: Oct. 14, 2010

(54) INFORMATION PROCESSING APPARATUS WITH TEXT DISPLAY FUNCTION, AND DATA ACQUISITION METHOD

(75) Inventors: Noriyuki Harada, Kawasaki (JP); Hiroshi Kanno, Kawasaki (JP); Eiji Miyazaki, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/731,846

(22) Filed: Mar. 25, 2010

(30) Foreign Application Priority Data
Apr. 14, 2009 (JP) 2009-098461

(51) Int. Cl. G06F 3/14; G06F 17/20

(52) U.S. Cl. 715/205; 715/255

(57) ABSTRACT

A link processing unit links the music data and the lyric data acquired by a data acquiring unit with each other. If corresponding data is not present, the link processing unit causes the data acquiring unit to acquire the corresponding data and store it in a storage unit so as to link the music data with the lyric data. If a replay processing unit replays the music data, a synchronous display unit reads the corresponding lyric data and displays the lyrics in accordance with the progression of replay.

### CROSS-REFERENCE TO RELATED APPLICATION(S)

This application is based upon and claims the benefit of priority of the prior Japanese Patent Application No. 2009-098461, filed on Apr. 14, 2009, the entire contents of which are incorporated herein by reference.

### FIELD

The embodiments discussed herein are directed to an information processing apparatus with a text display function that links content data with text data and displays text contained in the text data in accordance with the progression of replay of corresponding content data, and a data acquisition method of the information processing apparatus with the text display function.

### BACKGROUND

Heretofore, the replay of content data such as music or moving images has been used. The replay of the content data is performed by an information processing apparatus such as a mobile phone device or a computer device. Furthermore, lyrics are displayed as character information (text) with respect to the content data such as a song.

Especially, in a service, such as karaoke, where it is assumed that a user himself or herself sings a song, the content data for karaoke generated by combining data of the music part of a song and data of the lyric part of the song in advance is used so that corresponding lyrics are displayed in accordance with the progression of the music.

Furthermore, it is considered that music data and text data are synchronously replayed so that the same service as karaoke is provided. Because a service for distributing music data used for viewing and listening has been already spread, a user only needs to separately prepare text data of lyrics that corresponds to the music data.

However, if the user him- or herself creates the text data that corresponds to the music data, the creative load is heavy. Therefore, a service for providing text data is also considered.

If an information processing apparatus synchronously replays content data and text data, it is preferable to acquire both the content data and the text data in advance. If the information processing apparatus acquires the content data or the text data while replaying it, there is a possibility that the acquisition of data does not keep up with the replay and the replay of contents or the display of texts is interrupted. Especially, if the content data or the text data is acquired via communication, a problem occurs in that the content data or the text data fails to be acquired without establishing the communication and the synchronous replay fails to be performed.

### SUMMARY

According to an aspect of an embodiment of the invention, an information processing apparatus with a text display function includes a storage unit that stores therein content data and text data; a data acquiring unit that acquires at least one of content data and text data to store the acquired data in the storage unit; a link processing unit that causes the data acquiring unit, if text data corresponding to the acquired content data is not stored in the storage unit, to acquire the corresponding text data, and causes the data acquiring unit, if content data corresponding to the acquired text data is not stored in the storage unit, to acquire the corresponding content data; a replay processing unit that replays the content data on a display; and a synchronous display unit that displays text contained in the text data corresponding to the content data with progression of replay of the content data.

### BRIEF DESCRIPTION OF DRAWINGS

FIG. 1 is a configuration diagram of a mobile phone device that is an information processing apparatus with a text display function according to the present embodiment;

FIG. 2 is a hardware configuration diagram of a mobile phone device;

FIG. 3 is an explanatory diagram of music data and lyric data;

FIG. 4 is an explanatory diagram of replay of music data and synchronous display of lyric data;

FIG. 5 depicts a specific example of a display screen during the synchronous display of the lyrics;

FIG. 6 is a flowchart that illustrates an acquisition operation of corresponding data by a link processing unit;

FIG. 7 is a detailed flowchart of the download step S105 illustrated in FIG. 6;

FIG. 8 depicts an example of the display screen for requesting download possibility determination;

FIG. 9 depicts an example of the display screen for requesting link possibility determination;

FIG. 10 depicts an example of the display screen for notifying that download is impossible;

FIG. 11 depicts an example of the display screen for notifying that download is possible;

FIG. 12 is a flowchart that illustrates a processing operation of a synchronous display unit; and

FIG. 13 is a flowchart that illustrates the synchronous display process illustrated in FIG. 12 in detail.

### DESCRIPTION OF EMBODIMENT(S)

Preferred embodiments of the present invention will be explained with reference to accompanying drawings.

The disclosed technology is not limited to the embodiment.

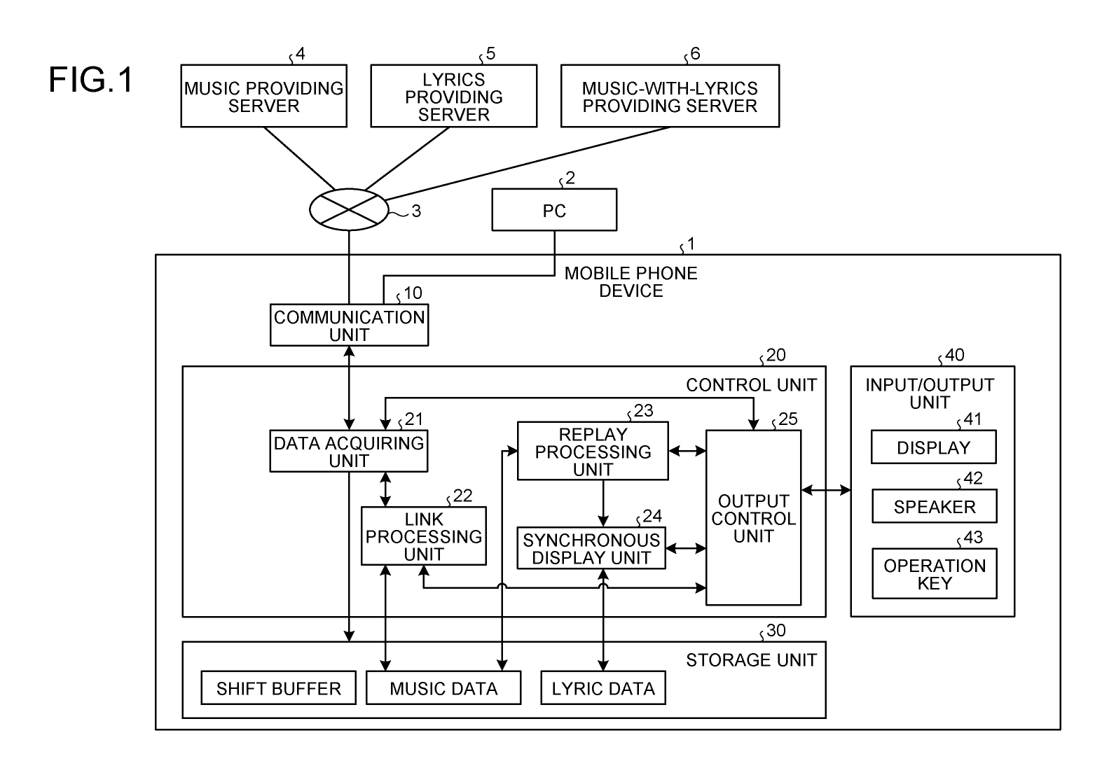

FIG. 1 is a configuration diagram of a mobile phone device that is an information processing apparatus with a text display function according to the present embodiment. A mobile phone device 1 illustrated in FIG. 1 includes therein a communication unit 10, a control unit 20, a storage unit 30, and an input/output unit 40.

The communication unit 10 communicates with an external device to acquire content data such as music and text data such as lyrics. Hereinafter, in the present embodiment, an explanation will be given by exemplifying a configuration in which lyrics are sequentially displayed in accordance with the replay of music by using music data as the content data and lyric data as the text data.

The communication unit 10 is connected to a music providing server 4, a lyrics providing server 5, and a music-with-lyrics providing server 6 via a network 3. The network 3 is, for example, the Internet, or the like. The mobile phone device 1 may be connected to the network 3 via, for example, a wireless Local Area Network (LAN) or via a mobile network provided by a mobile phone provider. Furthermore, the communication unit 10 is connected to a personal computer (PC) 2. The mobile phone device 1 can be connected to the personal computer 2 via an arbitrary system, for example, a Universal Serial Bus (USB), Bluetooth, or the like.

The music providing server 4, the lyrics providing server 5, or the music-with-lyrics providing server 6 is, for example, a HyperText Transfer Protocol (HTTP) server or a File Transfer Protocol (FTP) server. The music providing server 4 provides the mobile phone device 1 with music data via the network 3. The lyrics providing server 5 provides the mobile phone device 1 with lyric data via the network 3. The music-with-lyrics providing server 6 provides the mobile phone device 1 with music data and the corresponding lyric data via the network 3.

The personal computer 2 provides the mobile phone device 1 with music data or lyric data. The music data or the lyric data provided by the personal computer 2 is obtained by a method of, for example, acquiring it from a storage medium such as a Compact Disc (CD), acquiring it via a network, having it created by the user him- or herself, or the like.

The storage unit 30 stores therein music data and lyric data. A storage medium that can be used by a user to store arbitrary data, such as image data or phone number data, is generally provided in a mobile phone device. FIG. 1 depicts a state where music data and lyric data are stored in the storage unit 30, in which arbitrary data can be stored by the user. Illustrations and explanations will be omitted for other data stored in the storage unit 30. Furthermore, a shift buffer that causes lyrics to be displayed before the beginning of singing may be stored. A default value or a value designated by the user is stored in the shift buffer.

The input/output unit 40 is a user interface that includes a display 41, a speaker 42, an operation key 43, and the like. An arbitrary user interface, such as a touch panel display, can be used in addition to the illustrated ones.

The control unit 20 is a control unit that controls the operation of the mobile phone device 1. The control unit 20 has, as a function of a commonly-used mobile phone device, a function of making a call by connecting to a mobile network provided by a mobile phone provider. An explanation will be omitted for the calling function, and an explanation will be given of processing units relating to management of the content data and the text data.

The control unit 20 includes therein a data acquiring unit 21, a link processing unit 22, a replay processing unit 23, a synchronous display unit 24, and an output control unit 25.

The data acquiring unit 21 performs the process of acquiring music data and lyric data from the outside via the communication unit 10 and storing them in the storage unit 30. The link processing unit 22 performs the process of linking the music data with the lyric data.

The replay processing unit 23 performs the process of reading music data from the storage unit 30 and replaying it. Specifically, the replay processing unit 23 decodes the coded music data and sends sound data to the output control unit. Moreover, if images or moving images are contained in the music data, the replay processing unit 23 sends the images or the moving images to the output control unit 25. In addition, the replay processing unit 23 outputs information for identifying the music data to be replayed and outputs the progression status of the replay of music to the synchronous display unit 24.

The synchronous display unit 24 is a processing unit that displays lyric data in synchronization with the replay of music data performed by the replay processing unit 23. Specifically, the synchronous display unit 24 retrieves corresponding lyric data from the storage unit 30 by using information for identifying the music data output from the replay processing unit 23. The synchronous display unit 24 then sequentially displays a plurality of lyric phrases contained in the lyric data in accordance with the progression of replay of the music data by the replay processing unit 23. Specifically, the display by the synchronous display unit 24 is performed by outputting the lyric phrases to be displayed to the output control unit 25.

The output control unit 25 is a control unit that controls the display output of the display 41 and the sound output of the speaker 42. The output control unit 25 outputs the sound output from the replay processing unit 23 via the speaker 42. Furthermore, it generates the display screen that displays, on the display 41, the images or the moving images output from the replay processing unit 23 and the lyric phrases output from the synchronous display unit 24 in combination. Although the output control unit 25 resolves the conflict between various outputs if output requests for display or sound are generated by other functions, for example, the calling function, of the mobile phone device 1, its explanation will be omitted.

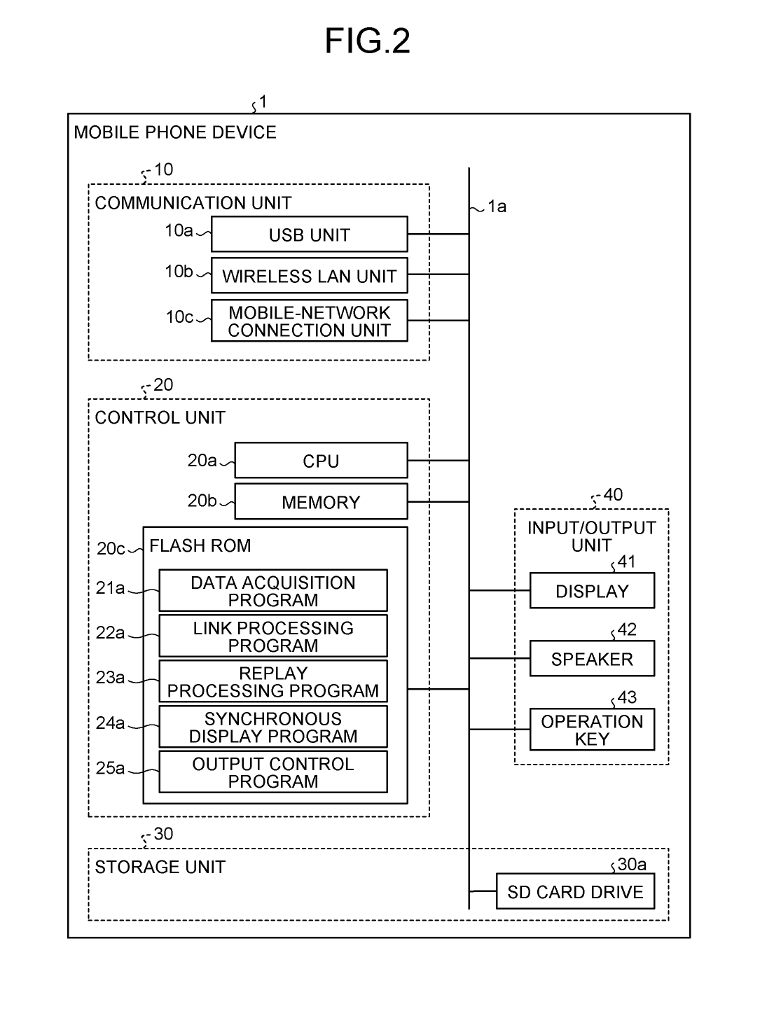

FIG. 2 is a hardware configuration diagram of the mobile phone device 1. In the mobile phone device 1, a USB unit 10a, a wireless LAN unit 10b, a mobile-network connection unit 10c, a Central Processing Unit (CPU) 20a, a memory 20b, a flash Read-Only Memory (ROM) 20c, an SD card drive 30a, the display 41, the speaker 42, and the operation key 43 are connected to a bus 1a.

The USB unit 10a, the wireless LAN unit 10b, and the mobile-network connection unit 10c perform the function of the communication unit 10. Specifically, the USB unit 10a is an interface that performs the USB connection with the personal computer 2. The wireless LAN unit 10b is an interface that is connected to the network 3 via an access point of the wireless LAN. The mobile-network connection unit 10c is an interface that is wirelessly connected to a mobile network provided by a mobile phone network provider.

The CPU 20a, the memory 20b, and the flash ROM 20c perform the function of the control unit 20. Specifically, the CPU 20a reads various programs stored in the flash ROM 20c, loads them in the memory 20b, and sequentially executes them, whereby various functions of the control unit 20 are performed. The flash ROM 20c stores therein a data acquisition program 21a, a link processing program 22a, a replay processing program 23a, a synchronous display program 24a, and an output control program 25a.

The data acquisition program 21a is executed by the CPU 20a so that the function of the data acquiring unit 21 is performed. The link processing program 22a is executed by the CPU 20a so that the function of the link processing unit 22 is performed. The replay processing program 23a is executed by the CPU 20a so that the function of the replay processing unit 23 is performed. The synchronous display program 24a is executed by the CPU 20a so that the function of the synchronous display unit 24 is performed. The output control program 25a is executed by the CPU 20a so that the function of the output control unit 25 is performed.

An area of the flash ROM 20c that can be arbitrarily used by the user and the SD card drive 30a function as the storage unit 30. Although a case where an SD card is used as the storage unit 30 is exemplified, an arbitrary storage medium can be used to implement the storage unit 30.

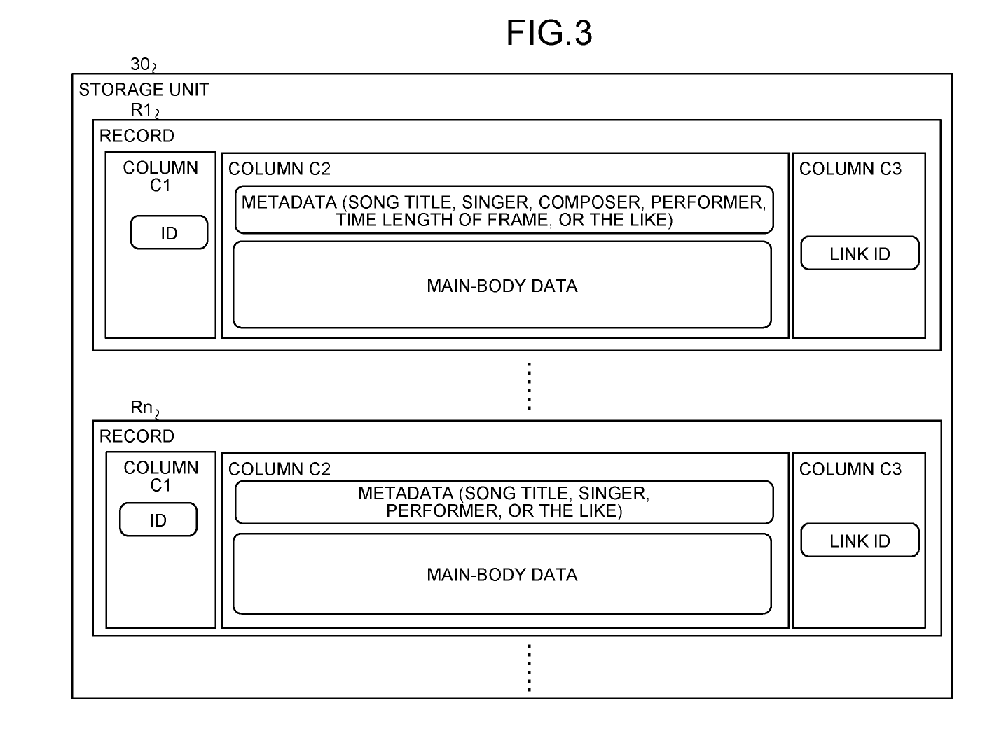

FIG. 3 is an explanatory diagram of music data and lyric data. The storage unit 30 stores therein the music data and the lyric data as records. Each of the records includes columns C1, C2, and C3. An identification information ID for uniquely identifying a record is stored in the column C1. The music data and the lyric data are stored in the column C2. The music data and the lyric data contain main-body data, which is data of music and lyrics themselves, and metadata, which is information about the music data and the lyric data.

In FIG. 3, a record R1 is the music data. The main-body data of the music data is constituted by a plurality of frames for which the replay order is determined. The metadata on the music data contains information on a song title, a singer, a composer, a performer, the time length of one frame, or the like. In addition, the metadata on the music data can contain arbitrary information on the bit rate of music, the specification used for codes, or the like.

In FIG. 3, a record Rn is the lyric data. The main-body data of the lyric data contains a group of lyric phrases and information that indicates the display timing of each of the phrases. The metadata on the lyric data contains information on a song title, a singer, a performer, or the like. There is a possibility that, even if the song title is identical, the timing at which each phrase of lyrics is displayed is changed depending on the performer. Information on the performer is contained in the metadata, and the music data and the lyric data are related to each other by using the information on the performer, whereby the display timing of the lyrics can correspond to the music. In the same manner, if, for example, the length of a performance, or the like, is different depending on a performance and the timing at which the lyric phrase is displayed is different although the music is identical, information on the length of the performance, the date and time of the performance, or the like, is contained. With respect to the music data, individual music data may be provided for different performers, different dates and times of performances, or the like. In addition, the metadata on lyrics can contain arbitrary information on a lyric writer, or the like.

The column C3 has a link ID that is information for linking records. The link ID is an ID of a corresponding record. If the music data of the record R1 is linked with the lyric data of the record Rn, the ID of the record Rn is stored in the column C3 as the link ID of the record R1. In the same manner, the ID of the record R1 is stored in the column C3 as the link ID of the record Rn.

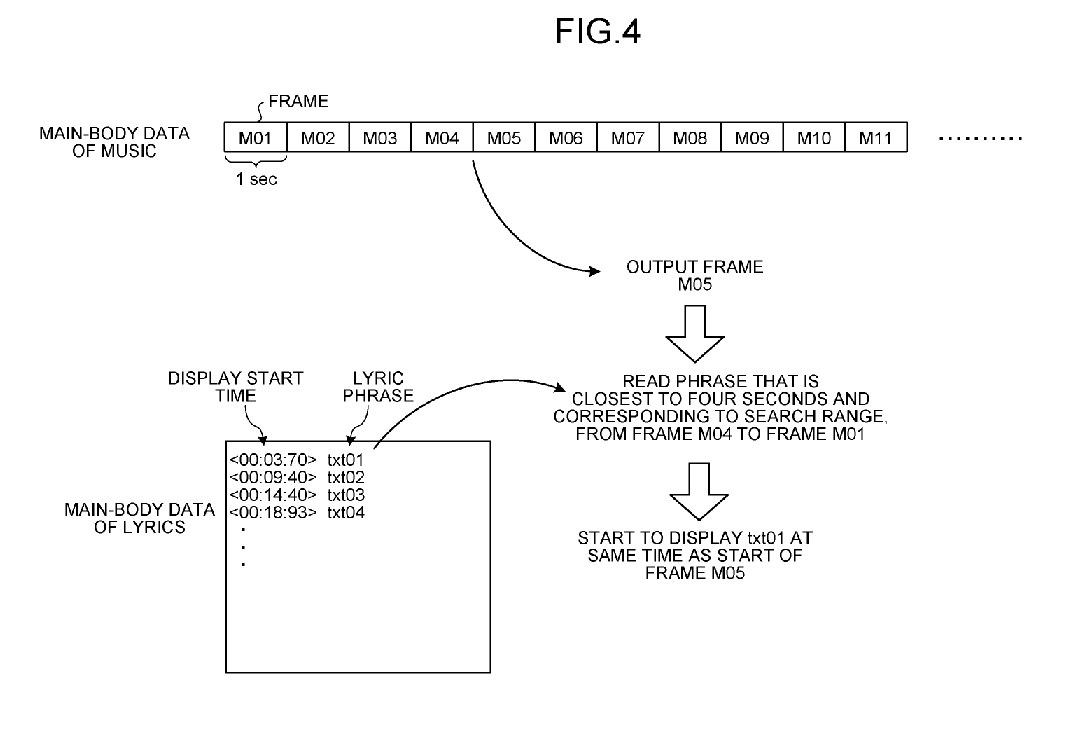

FIG. 4 is an explanatory diagram of the replay of music data and the synchronous display of lyric data. In the example illustrated in FIG. 4, the main-body data of the music is constituted by a plurality of frames in which the length of one frame is one second. Furthermore, the replay order of each frame is determined. In other words, each frame of the music data is obtained by separating the music every one second and assigning a frame number that indicates the replay order. When the replay of the music is started, a frame M01 is first output. The output of the frame M01 is terminated after one second. Then, the successive frames, i.e., a frame M02 and a frame M03, are sequentially output. The replay of the music is finished when the output of the final frame is terminated.

Moreover, in the example illustrated in FIG. 4, the main-body data of the lyrics contains a plurality of lyric phrases and the display start time of each of the lyric phrases. The display start time functions as information that indicates the timing at which each of the lyric phrases is displayed. Each of the lyric phrases is displayed from the display start time to the display start time of the subsequent lyric phrase.

In the example illustrated in FIG. 4, the display of a lyric phrase txt01 is started four seconds after the replay of the music is started. Afterwards, the lyric phrase txt01 is changed to a lyric phrase txt02 9 seconds after the replay of the music is started. Then, the lyric phrase txt02 is changed to a lyric phrase txt03 14 seconds after the replay of the music is started, and the lyric phrase txt03 is changed to a lyric phrase txt04 19 seconds after the replay of the music is started. The display of the lyric phrase is terminated in accordance with the termination of the replay of the music. The content of a lyric phrase is left blank so that it is possible to implement a state where lyrics are not displayed. Furthermore, if a shift buffer is set to display lyrics prior to the beginning of singing in the music, the display timing of the lyrics is put forward for the time set in the shift buffer. Specifically, the display timing of the lyric phrase is determined in accordance with the value obtained by subtracting the time set in the shift buffer from the display start time of the lyric phrase. For example, in the example illustrated in FIG. 4, if one second is set in the shift buffer, when the frame M04 is read three seconds after the replay of the music is started, the display of the lyric phrase txt01 is started, which is the phrase closest to three seconds and corresponds to the search range, from the frame M04 to the frame M01 among the phrases for which one second is subtracted from the display start time of each of the lyric phrases, i.e., the lyrics are displayed after 3.70−1=2.70 seconds. Afterwards, when the frame M10 is read nine seconds after the replay of the music is started, the lyric phrase txt01 is changed to the lyric phrase txt02, which is the phrase closest to nine seconds and corresponds to the search range, from the frame M10 to the frame M01 among the phrases for which one second is subtracted from the display start time of each of the lyric phrases, i.e., the lyrics are displayed after 9.40−1=8.40 seconds.

The replay processing unit 23 notifies the synchronous display unit 24 of the identification information ID of the music to be replayed when the replay of the music is started. Then, after the replay is started, the replay processing unit 23 notifies the synchronous display unit 24 of the output status of the frames.

The synchronous display unit 24 retrieves a record that has the identification information ID notified by the replay processing unit 23 as the link ID. The replay processing unit 23 reads the record obtained as a result of retrieval as lyric data that corresponds to the music data to be replayed. Afterwards, the synchronous display unit 24 calculates the elapsed time of the replay from the output status of the frames and reads the lyric phrase in accordance with the calculated elapsed time.

For example, if it is notified by the replay processing unit 23 that a frame M05 that is the fifth frame is to be output, the synchronous display unit 24 multiplies the frame number “5” by the frame length “one second” and recognizes that the frame M05 corresponds to the fifth second of the music. Then, the synchronous display unit 24 reads the lyric phrase whose designated display start time is closest to four seconds and corresponds to the search range, from the frame M05 to the frame M01. In the example illustrated in FIG. 4, the display start time of the lyric phrase txt01 is 3.7 seconds. Because the output start time of the frame M05 is four seconds, the synchronous display unit 24 starts the display of the lyric phrase txt01 at the output start time of the frame M05. Therefore, the display of the lyric phrase txt01 is started four seconds after the replay of the music is started.

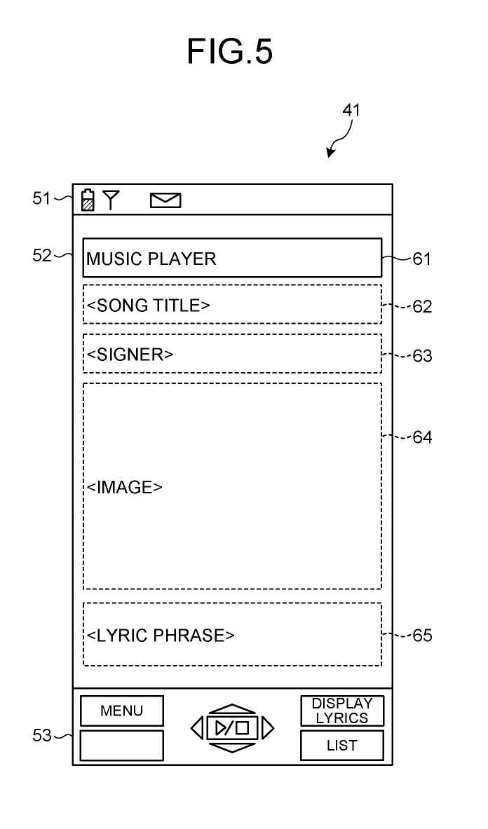

FIG. 5 depicts a specific example of the display screen during the synchronous display of the lyrics. The display screen of the display 41 is generated and displayed by the output control unit 25. The display screen includes a device-status display area 51, a main display area 52, and an operation area 53.

The device-status display area 51 is an area for displaying the status of the mobile phone device 1. The status of the mobile phone device 1 includes, for example, the charge status of its battery, the reception status of radio signals, or the like. The operation area 53 is an area for supporting a user operation by displaying an operation executed when the operation key 43 is operated.

The output control unit 25 displays various types of information on the main display area 52 if the music data is being replayed. Specifically, the output control unit 25 generates a function-name display area 61, a song-title display area 62, a singer display area 63, an image display area 64, and a lyric-phrase display area 65 on the main display area 52.

The output control unit 25 displays, on the function-name display area 61, that the music replay function is being executed. The output control unit 25 displays, on the song-title display area 62, information on the song title acquired from the metadata on the music data. The output control unit 25 displays, on the singer display area 63, information on the singer acquired from the metadata on the music data. The output control unit 25 displays images of the music data on the image display area 64. The images of the music data are, for example, moving images, pictures of a cover, or the like. The output control unit 25 displays, on the lyric-phrase display area 65, the lyric phrase designated by the synchronous display unit 24.

If the state is such that corresponding music data and lyric data are stored in the storage unit 30, the synchronous replay can be performed so as to synchronously display the lyrics in accordance with the replay of the music. On the other hand, if the music data or the lyric data is acquired when being replayed, there is a possibility that the acquisition of the data does not keep up with the replay and the replay of the music or the display of the lyrics is interrupted. Especially, if the music data or the lyric data is acquired via communication, the music data or the lyric data fails to be acquired without establishing the communication and the synchronous replay fails to be performed.

Therefore, with respect to unlinked data for which corresponding data is not present in the storage unit 30, i.e., the link ID is not set, among the music data and the lyric data, the link processing unit 22 prompts the acquisition of the corresponding data. The retrieval of unlinked data may be performed at the timing designated by the user or may be performed if new music data or lyric data is acquired.

If the data acquiring unit 21 acquires new music data or lyric data, the data acquiring unit stores the acquired data in the column C2 of a record. Furthermore, it assigns an ID to the acquired data and stores it in the column C1. Moreover, the data acquiring unit 21 notifies the link processing unit 22 of the acquisition of the data. Thus, notification is made to the link processing unit 22 when new data is acquired, whereby the retrieval of unlinked data by the link processing unit 22 can be started.

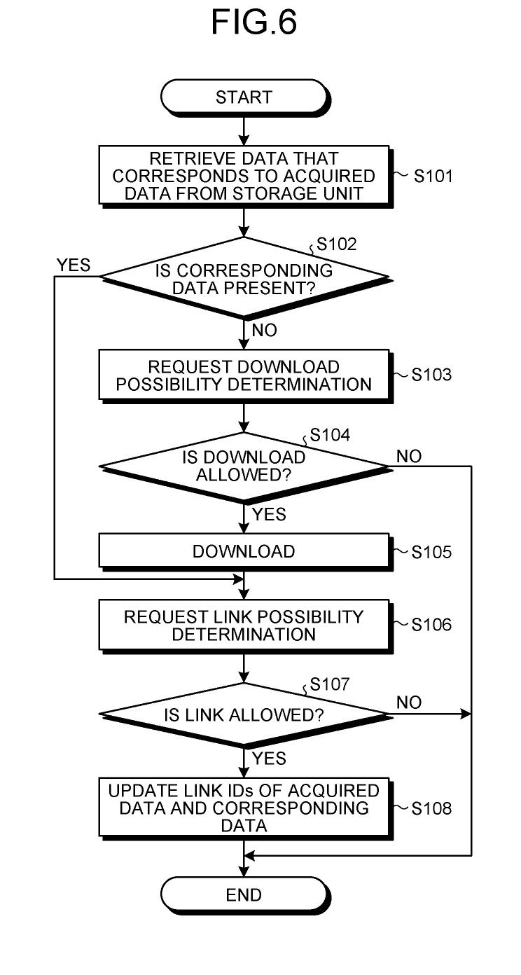

Specifically, the link processing unit 22 receives notification from the data acquiring unit 21 and performs the processing operation illustrated in FIG. 6. FIG. 6 is a flowchart that illustrates the acquisition operation of corresponding data by the link processing unit 22.

The link processing unit 22 first retrieves the corresponding data that corresponds to the acquired data from the storage unit 30 (S101). The retrieval depending on the presence or absence of the link ID, the retrieval using metadata, or the like, can be used for the retrieval of the corresponding data.

In the retrieval depending on the presence or absence of the link ID, as a candidate for the corresponding data, the link processing unit 22 determines the data for which the link ID is not set. If the retrieval using metadata is performed, the data acquiring unit 21 notifies the link processing unit 22 of the metadata of the acquired data as well as the acquisition of the data. The link processing unit 22 performs the retrieval in the storage unit 30 by using the metadata of the acquired data and determines the data for which a song title, a singer, a performer, or the like is identical as a candidate for the corresponding data. Data for which the link ID is not set and for which a song title, a singer, a performer, or the like is identical may be a candidate for the corresponding data. Furthermore, if the acquired data is music data, only lyric data may be a candidate and, if the acquired data is lyric data, only music data may be a candidate.

The link processing unit 22 displays candidates for the corresponding data and determines the corresponding data in accordance with a selection input from the user. If the correspondence between the music data and the lyric data can be surely determined in accordance with the presence or absence of the link ID, the comparison of the metadata, or the like, the display of candidate data or the selection input from the user may be omitted.

If the corresponding data that corresponds to the acquired data is present in the storage unit 30 (S102, Yes), the link processing unit 22 proceeds to Step S106 that is described later. On the other hand, if the corresponding data that corresponds to the acquired data is not present in the storage unit 30 (S102, No), the link processing unit 22 requests download possibility determination of the corresponding data (S103) to the user.

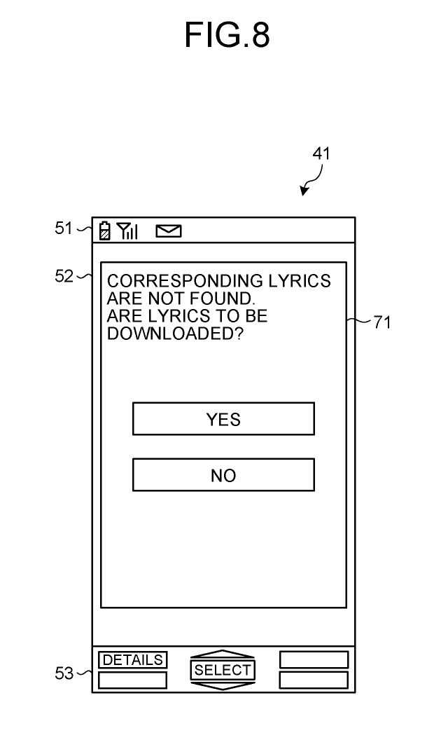

FIG. 8 depicts an example of the display screen for requesting the download possibility determination. The display screen illustrated in FIG. 8 is an example in a case where the corresponding lyric data is not present when the music data is acquired and the display screen displays a download-possibility determination display 71 on the main display area 52. The download-possibility determination display 71 includes a message “Corresponding lyrics are not found. Are the lyrics to be downloaded?” and button images to receive an operation input “Yes” or “No”. The user can select “Yes” or “No” by operating the operation key 43.

If the operation input “No” is received with respect to the download possibility determination, i.e. the download of the corresponding data is not allowed in FIG. 6 (S104, No), the link processing unit 22 terminates the process.

On the other hand, if the operation input “Yes” is received with respect to the download possibility determination, i.e., the download of the corresponding data is allowed in FIG. 6 (S104, Yes), the link processing unit 22 causes the data acquiring unit 21 to download the corresponding data (S105).

After the download of the corresponding data is finished or if the corresponding data is already present in the storage unit 30 (S102, Yes), the link processing unit 22 requests link possibility determination for the acquired data and the corresponding data (S106) to the user.

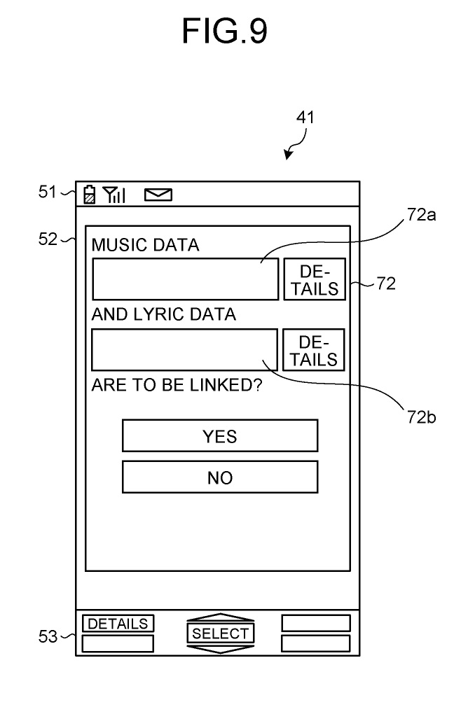

FIG. 9 depicts an example of the display screen for requesting link possibility determination. The display screen illustrated in FIG. 9 displays a link-possibility determination display 72 on the main display area 52. The link-possibility determination display 72 includes a message “Are music data 72a and lyric data 72b to be linked?”, button images to receive an instruction for displaying detailed information on the music data and the lyric data, and button images to receive an operation input “Yes” or “No”. The music data 72a and the lyric data 72b are information used by the user to identify a record and part of the metadata may be used. Furthermore, the user inputs an instruction for displaying the detailed information by operating the operation key 43 so that the detailed information on the music data or the lyric data can be displayed. If the instruction for displaying the detailed information is received, the link processing unit 22 displays the metadata of the corresponding record, or the like. Moreover, the user can select “Yes” or “No” by operating the operation key 43.

If the operation input “No” is received with respect to the link possibility determination, i.e., the link between the acquired data and the corresponding data is not allowed in FIG. 6 (S107, No), the link processing unit 22 terminates the process.

On the other hand, if the operation input “Yes” is received with respect to the link possibility determination, i.e., the link between the acquired data and the corresponding data is allowed in FIG. 6 (S107, Yes), the link processing unit 22 updates the link IDs of the acquired data and the corresponding data (S108) and terminates the process. Specifically, the update of the link ID is the process of writing the ID of the corresponding data in the column C3 of the acquired data as the link ID and writing the ID of the acquired data in the column C3 of the corresponding data as the link ID.

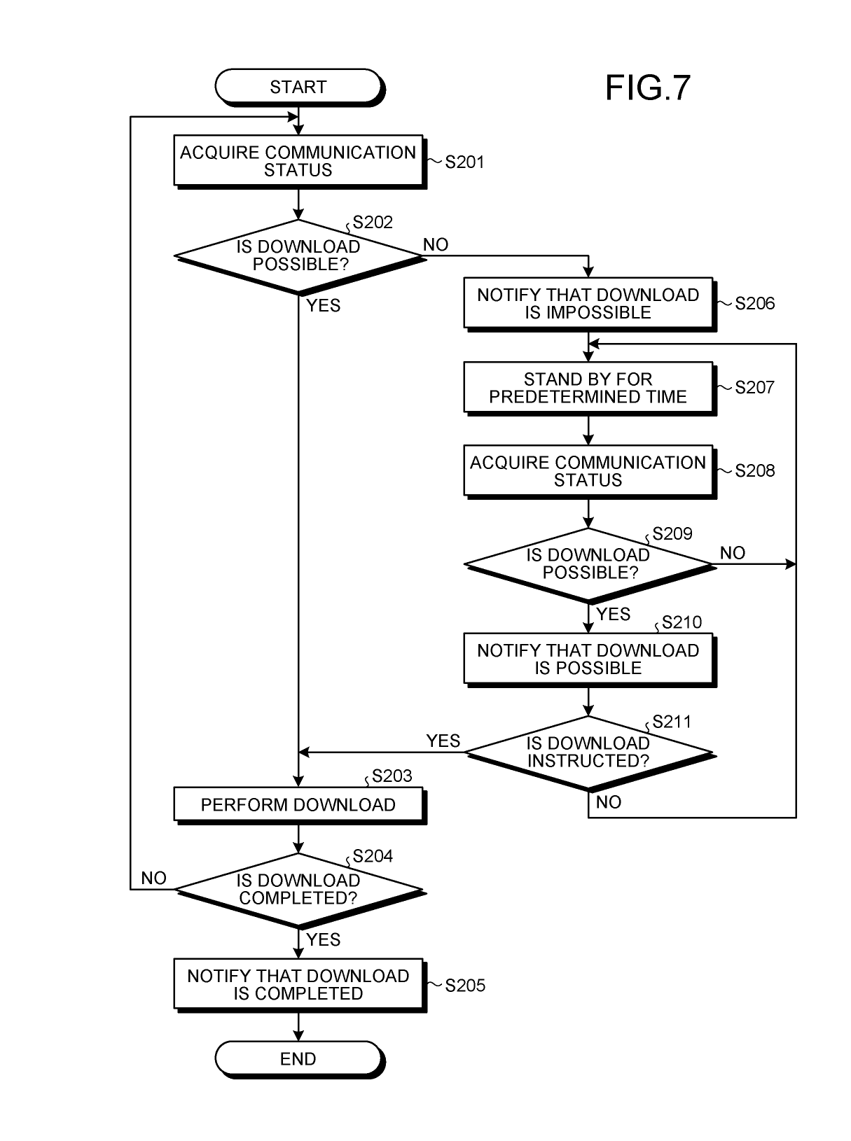

FIG. 7 is a detailed flowchart of the download step S105 illustrated in FIG. 6. Upon receiving an instruction for downloading the corresponding data from the link processing unit 22, the data acquiring unit 21 acquires the communication status of the communication unit 10 (S201).

As a result, if the communication status is such that the download of the corresponding data is possible (S202, Yes), the data acquiring unit 21 performs the download of the corresponding data (S203). As a result, if the download of the corresponding data is completed (S204, Yes), the data acquiring unit 21 notifies the link processing unit 22 of completion of the download (S205) and terminates the process. If the download is not completed (S204, No), the data acquiring unit 21 returns to Step S201 to acquire the communication status.

If the communication status is not such that the download of the corresponding data is possible (S202, No), the data acquiring unit 21 notifies the link processing unit 22 that the download is impossible (S206). The link processing unit 22 receives notification that the download is impossible and notifies the user that the download is impossible.

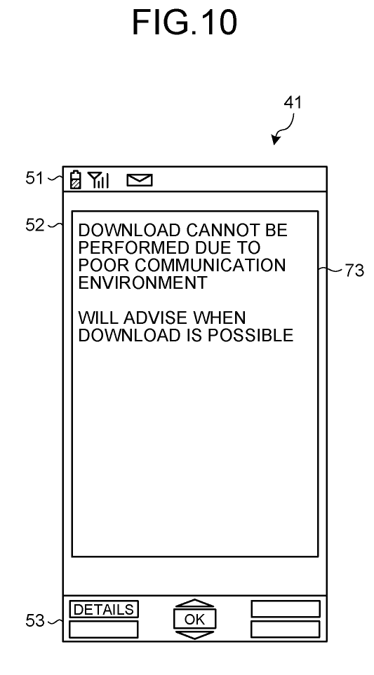

FIG. 10 depicts an example of the display screen for notifying that the download is impossible. The display screen illustrated in FIG. 10 displays a download-impossible notification display 73 on the main display area 52. The download-impossible notification display 73 displays a message “Download cannot be performed due to poor communication environment. Will advise when the download is possible”.

After Step S206, the data acquiring unit 21 stands by for a predetermined time (S207) and acquires the communication status of the communication unit 10 again (S208). As a result, if the communication status is not such that the download is possible (S209, No), the data acquiring unit 21 stands by again for the predetermined time (S207).

If the state is such that the download is possible as a result of the acquisition of the communication status at Step S208 (S209, Yes), the data acquiring unit 21 notifies the link processing unit 22 that the download is possible (S210). The link processing unit 22 receives notification that the download is possible and notifies the user that the download is possible.

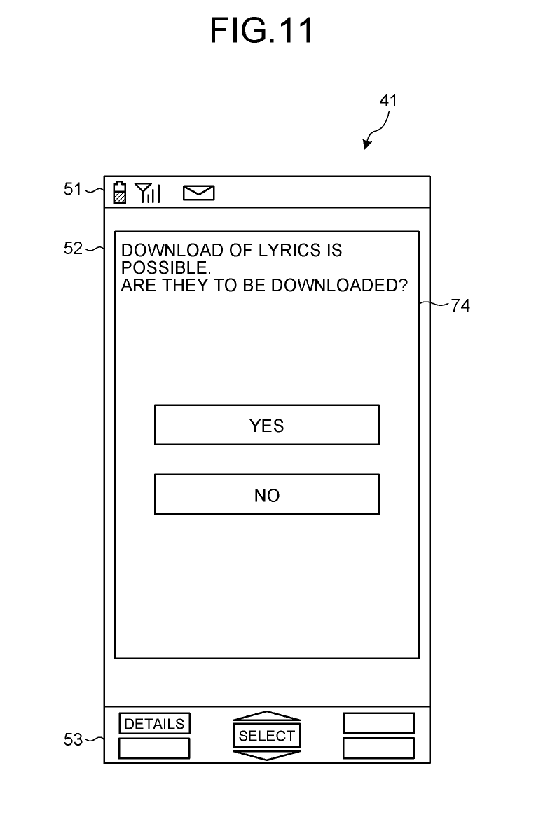

FIG. 11 depicts an example of the display screen for notifying that the download is possible. The display screen illustrated in FIG. 11 displays a download-possible notification display 74 on the main display area 52. The download-possible notification display 74 includes a message “Download of lyrics is possible. Are they to be downloaded?” and button images to receive an operation input “Yes” or “No”. The user can select “Yes” or “No” by operating the operation key 43.

If the operation input “No” is received with respect to the download-possible notification, i.e., the download is not instructed in FIG. 7 (S211, No), the data acquiring unit 21 stands by for the predetermined time (S207) and afterwards acquires the communication status again (S208).

On the other hand, if the operation input “Yes” is received with respect to the download-possible notification, i.e., the download is instructed in FIG. 7 (S211, Yes), the data acquiring unit 21 performs the download of the corresponding data (S203).

Thus, the link processing unit 22 causes the data acquiring unit 21 to acquire corresponding data with respect to unlinked data and assigns correspondence therebetween, whereby corresponding music data and lyric data can be stored in the storage unit 30. Although the process for requesting a confirmation input from the user with respect to the download possibility determination (S103), the link possibility determination (S106), and the download instruction (S211) is exemplified in FIGS. 6 and 7, the confirmation by the user can be omitted.

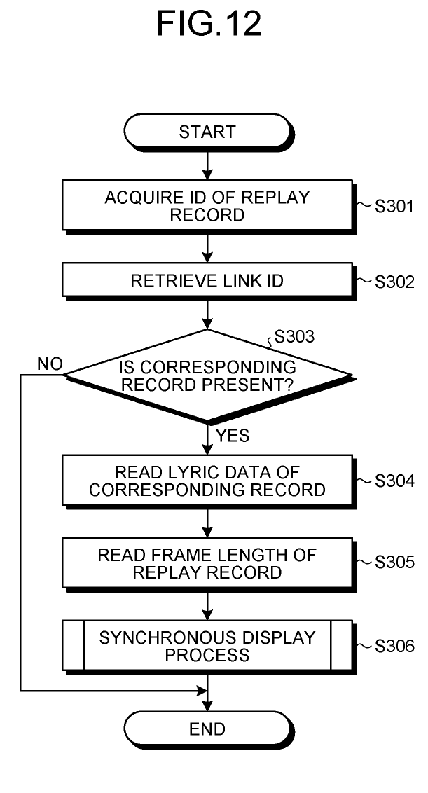

Next, an explanation will be given of a processing operation of the synchronous display unit 24. FIG. 12 is a flowchart that illustrates the processing operation of the synchronous display unit 24. The synchronous display unit 24 acquires the ID of the replayed record from the replay processing unit 23 (S301) and retrieves the corresponding record that has the acquired ID as the link ID in the column C3 (S302). As a result of retrieval, if the corresponding record is not present (S303, No), the synchronous display unit 24 terminates the process.

On the other hand, if the corresponding record is present (S303, Yes), the synchronous display unit 24 reads the lyric data from the column C2 of the corresponding record (S304). Furthermore, the synchronous display unit 24 performs retrieval in the storage unit 30 by using the ID of the replayed record and reads the frame length from the metadata of the replayed record (S305). The synchronous display unit 24 performs the synchronous display process by using the read lyric data and the read frame length (S306) and terminates the process.

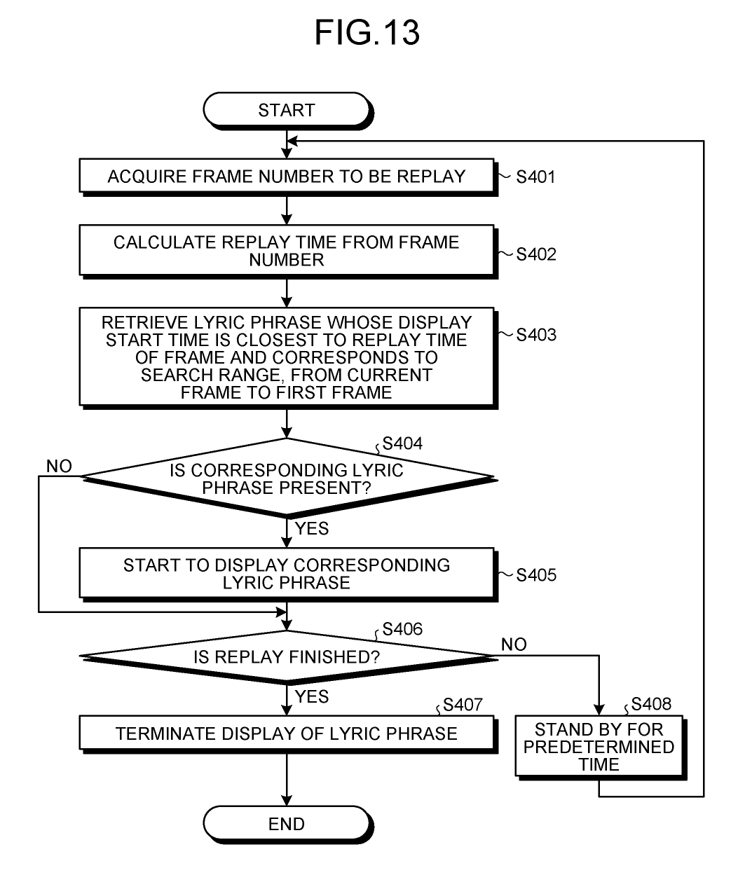

FIG. 13 is a flowchart that illustrates the synchronous display process illustrated in FIG. 12 in detail. The synchronous display unit 24 acquires the frame number of the frame to be replayed from the replay processing unit 23 (S401).

The synchronous display unit 24 calculates the replay time of the frame from the acquired frame number and the frame length (S402). Then, it retrieves a lyric phrase whose display start time falls within the replay time of the frame (S403).

If a lyric phrase whose display start time falls within the replay time of the frame is present (S404, Yes), the display of the corresponding lyric phrase is started (S405). If the previous lyric phrase is being displayed when the display is started, the display of the previous lyric phrase is deleted and updated.

After Step S405 is terminated or if a lyric phrase whose display start time falls within the replay time of the frame is not present (S404, No), the synchronous display unit 24 determines whether the replay of the music data by the replay processing unit 23 has been completely finished (S406).

If the replay of the music data has not been finished (S406, No), the synchronous display unit 24 stands by until the frame ends (S408) and acquires the frame number to be replayed (S401). Then, if the replay of the music data has been finished (S406, Yes), the synchronous display unit 24 terminates the display of the lyric phrase (S407).

In the processing operation illustrated in FIG. 13, the synchronous display unit 24 displays the lyrics in accordance with the number of the frame to be output. Therefore, the corresponding lyrics can be correctly displayed even if the music is generated during fast-forward or fast-rewind.

As described above, according to the present embodiment, in the synchronous replay of the music data and the lyric data, the mobile phone device 1 can perform synchronous replay in a smooth manner by acquiring the corresponding data before replaying it. Furthermore, the acquisition of the corresponding data can be controlled in accordance with the communication status.

The present embodiment is only an example, and the disclosed technology can be changed as appropriate and implemented. For example, although the configuration in which both music data and lyric data are stored in the storage unit 30 is exemplified in the present embodiment, the music data and the lyric data may be separately stored in a plurality of storage units. Moreover, a storage unit in which the music data is stored and a storage unit in which the lyric data is stored may be separately arranged.

Furthermore, although the case is exemplified in the present embodiment where the corresponding lyric data is acquired after the music data is acquired, it is possible that the corresponding music data is acquired after the lyric data is acquired. Moreover, it is possible that the corresponding data is identified and acquired when the metadata of one set of data is acquired.

Furthermore, if both corresponding music data and lyric data can be both provided as in the music-with-lyrics providing server 6, a provider of the data may determine the presence or absence of the corresponding data and prompt the mobile phone device 1 to acquire the corresponding data as well.

Corresponding data does not need to be acquired from the same place and, for example, the music data may be acquired from the personal computer 2 and the lyric data may be acquired from the lyrics providing server 5.

Furthermore, according to the present embodiment, the music data is illustrated as an example of the content data and the lyric data as an example of the text data. This is only an example, and arbitrary contents whose output is changed in accordance with the passage of time can be used as the content data. In the same manner, arbitrary data whose displayed contents are changed in accordance with the replay of the content data can be used as the text data. Furthermore, the sound output may not be necessary for the content data, and only the displayed contents may be changed over time.

For example, the disclosed technology can be applied by using a movie as the content data and a caption as the text data Furthermore, it may be moving images with character information such as telop attached thereto.

Moreover, although an explanation is given in the present embodiment by exemplifying the case where the content data has a one-to-one correspondence with the text data, the correspondence between the content data and the text data is not limited to one-to-one. For example, if the content data is a movie, it is useful to correspond with a plurality of sets of text data such as English captions and Japanese captions. Moreover, different lyrics may be present for identical music. In the same manner, even if a plurality of sets of music data has different arrangement for music tone, or the like, one set of text data can correspond with a plurality of sets of music data as long as the contents of the lyrics and the display timing are identical.

Furthermore, although the case is exemplified in the present embodiment where the output timing of the frame of the music corresponds with the display timing of the lyric phrase, it is possible that the difference between the display start time of the lyric phrase and the output timing of the frame of the music is calculated and the lyric phrase is displayed with a shift corresponding to the time calculated from the output timing of the frame of the music so that the display of the lyric phrase is started at a designated display start time.

Moreover, although a mobile phone device is illustrated as an example of an information processing apparatus with a text display function in the present embodiment, the disclosed technology can be applied to an arbitrary information processing apparatus such as a personal computer. Furthermore, the disclosed technology can be provided as a program that includes the data acquisition program 21a and the link processing program 22a.

An information processing apparatus with a text display function, a data acquisition method, and a data acquisition program disclosed in the present application can produce an advantage that, during synchronous replay of content data and text data, corresponding data is acquired before being replayed so that synchronous replay can be performed in a smooth manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus with a text display function, comprising:
a storage unit that stores therein content data and text data;
a data acquiring unit that acquires at least one of content data and text data to store the acquired data in the storage unit;
a link processing unit that causes the data acquiring unit, if text data corresponding to the acquired content data is not stored in the storage unit, to acquire the corresponding text data, and causes the data acquiring unit, if content data corresponding to the acquired text data is not stored in the storage unit, to acquire the corresponding content data;
a replay processing unit that replays the content data on a display; and
a synchronous display unit that displays text contained in the text data corresponding to the content data with progression of replay of the content data.

2. The information processing apparatus according to claim 1, further comprising a communication unit that communicates with an external device, wherein
the data acquiring unit acquires the at least one of content data and text data through via the communication unit, and
the link processing unit controls acquisition of the corresponding data in accordance with a communication status of the communication unit.

3. The information processing apparatus according to claim 1, wherein
the content data is data on music and contains metadata in which at least one of a singer's name of the music, a song title, a performer's name, and a title of an album that contains the music can be included,
the text data is data on lyrics and contains metadata in which at least one of a singer's name of a corresponding music, a song title, a performer's name, and a title of an album that contains the corresponding music can be included, and
the link processing unit compares the metadata of the content data with the metadata of the text data and links the content data with the text data.

4. A data acquisition method, comprising:
acquiring at least one of content data and text data to store the acquired data in a storage unit;
acquiring, if text data corresponding to the acquired content data is not stored in the storage unit, the corresponding text data, and acquiring, if content data corresponding to the acquired text data is not stored in the storage unit, the corresponding content data;
replaying the content data on a display; and
displaying text contained in the text data corresponding to the content data with progression of replay of the content data.

5. A computer readable storage medium having stored therein a data acquisition program, the data program causing a computer to execute a process comprising:
acquiring at least one of content data and text data to store the acquired data in a storage unit;
acquiring, if text data corresponding to the acquired content data is not stored in the storage unit, the corresponding text data, and acquiring, if content data corresponding to the acquired text data is not stored in the storage unit, the corresponding content data;
replaying the content data on a display; and
displaying text contained in the text data corresponding to the content data with progression of replay of the content data.
